(19) United States
(12) Patent Application Publication
(10) Pub. No.: US 2020/0272650 A1
(43) Pub. Date: Aug. 27, 2020

(54) METHOD OF FACILITATING QUERIES OF A TOPIC-BASED-SOURCE-SPECIFIC SEARCH SYSTEM USING KEY TERM CLUSTERS

(71) Applicant: Robert Michael DESSAU, New York, NY (US)

(72) Inventor: Robert Michael DESSAU, New York, NY (US)

(21) Appl. No.: 16/283,328

(22) Filed: Feb. 22, 2019

(51) Int. Cl. G06F 16/35; G06F 16/33; G06F 16/31

(52) U.S. Cl. CPC G06F 16/358; G06F 16/313; G06F 16/3334; G06F 16/353

(57) ABSTRACT

Approaches for facilitating queries of a topic-based-source-specific search system using key term clusters relating to key terms contained within information items. In certain implementations, an input relating to a query may be received. One or more predefined sources and information items may be determined based on the received input. In some implementations, the system may be configured determine one or more key terms from the information items and to display the one or more key terms in a key term cluster. The visual representations, such as color, size, shape, position, and area, of the key terms in the key term cluster may depend on information relating to the corresponding key terms.

### FIELD OF THE INVENTION

The invention relates to a topic-based-source-specific search system, including, among other aspects, presentation of search results, determination of key terms and key term associations, visualization of key terms relating to search results in key term dusters, or other features based on queries of a topic-based-source-specific search system.

### BACKGROUND OF THE INVENTION

Numerous disparate sources of government information exist. These sources include government websites, intergovernmental agency websites, news websites, and other sources. One problem with existing systems and methods for accessing this information is the need to expend resources to separately monitor and read individual information sources to discover trends and patterns of the use of certain terms, rather than having information relating to certain key terms presented in a visually digestible manner.

### SUMMARY OF THE INVENTION

The invention addressing these and other drawbacks relates to methods, apparatuses, and/or systems for facilitating queries of a topic-based-source-specific search system using key term clusters. In exemplary embodiments, a plurality of predefined sources of government information may be pre-selected for the topic based-source-specific search system. The predefined sources and information items may have information pertaining to or relating to various entities, including corporate entities, professional entities, or more. The predefined sources and information items contain certain terms or phrases relating to things, people, places, organizations, and other institutions. The predefined sources and information items of the predefined sources may be processed.

Metadata indicating various attributes of the predefined sources or the information items may be indexed and stored in association with the predefined sources or the information items, including information pertaining to: an association between the information items or sources and predefined entities; information pertaining to an association between the information items or sources and predefined entity aliases; information pertaining to an association between the information items or sources and one or more predefined search tools; and information pertaining to terms contained with the information items. The search system, user interfaces of the search system, or other components of the search system may be configured to provide: (i) the determination of key terms contained within the one or more of the information items; (ii) the categorization of key terms based their relative importance or their association with other key terms; and (iii) the visualization of key terms in a key term cluster.

A system for facilitating queries of a topic-based source-specific search system may comprise one or more servers (or other components) that include one or more processors configured to execute one or more computer program modules. The computer program modules may include a query input module, a key term module, a user interface module, an information retrieval module, an indexing module, a search tool module, an entity mention filter module, or other modules.

In some implementations, the computer-implemented method of facilitating queries of a topic-based-source-specific search system may be configured to collect and visualize information from predefined sources containing one or more terms. In certain implementations, the system may be configured to provide a query input component configured to receive user input on a display of a user interface. Further, the system may be configured to receive an input relating to a query. In certain implementations, the system may be configured to determine a subset of information items that relate to the received input and a determined subset of sources associated with the subset of the information items.

In exemplary implementations, the system may be configured to determine key terms contained in one or more information items of the subset of information items based on a key term determination. In some implementations, the key term determination may involve determining that a term contained within one or more information items of the determined subset of information items has a key term score greater than a key term threshold value.

In some implementations, a key term score may be based on a key term intensity score, which may consider at least one or more of the number of times a term is contained in a subset of information items; the number of information items in a subset of information items containing a term; and a statistical correspondence between a term and a subset of information items.

In some implementations, a key term score may be based on an emerging key term score, which may involve determining a change in a key term score, for one or more terms contained in a subset of information items, across different time periods, where at least one time period is at least partially before a second time period. That is, an emerging key term score may indicate whether a term's key term intensity score has increased or decreased over period of time.

In some implementations, a key term score may be based exclusively on either a key term intensity score or an emerging key term score. In other implementations, implementations, a key term score may be based on a combination of at least a key term intensity score and an emerging key term. In some implementations, one or more key terms may have a term type. In exemplary embodiments, a term type may be one or more of a keyword, a name, a place, or an organization. In some implementations, key terms have be indexed and stored in association with one or more of the term types.

In example embodiments, the system may be configured to determine one or more header terms of the key terms based on a header term determination. In certain embodiments, a header term determination may comprise determining that a key term has a key term score that is greater than a header term threshold value. In other embodiments, the header term determination may comprise determining a set of terms having the highest key term score.

In example embodiments, the system may be configured to determine one or more associated terms of the key terms based on an associated term determination, wherein each of the associated terms have an association with one or more header terms. In certain implementations, an associated term determination may involve determining that a key term and a header term have an association score greater than an association term threshold value, wherein the association score may be based on one or more of: the number times the key term and the header term are contained in same information item; for information items containing both the key term and the header term, the number times the key term and the header term appear within the information item; for information items containing both the key term and the header term, the character distance between one or more of the key terms and the one or more header terms within the information item; and a statistical correspondence between the header term and the key term.

In some implementations, the system may be configured to provide a representation of a key term cluster area comprising a key term cluster on a display of a user interface. In certain embodiments, the key term cluster may contain a header term area and an associated term area. In some embodiments, the system may provide a representation of a first header term of one or more header terms in the header term area of a key term cluster and one or more representations of one or more first associated terms in the associated term area of the key term cluster, wherein the one or more first associated terms have an association with the first header term. In this way, the system may be configured to provide a key term cluster visually representing associations between associated terms and corresponding header terms.

In certain implementations, a key term may be represented on the display of the user interface as a graphical object having an area and a color, wherein the color may be based on the term type of the key term represented by the graphical object. In various implementations, the area of a graphical object may be based the association score or the key term score of the key term represented by the graphical object. Thus, in accordance with the embodiments set forth herein, a key term cluster with color-coded key terms with variable areas may provide a user with useful presentation of key terms based on their term type as well as their association with other terms.

In various implementations, the key term clusters, the header terms, and the associated may represented by one or more rectangles. In certain implementations, the header term area of a key cluster may occupy the top-left most region of the key term cluster. In certain embodiments, the associated terms of a key term cluster may be positioned after the header term a sequence that is based on at least one of association an association between an associated term and the header term and a key term score of an associated term.

In other implementations, the key term clusters, the header terms, and the associated terms may represented by one or more circles. In various embodiments, the header term area may positioned substantially towards the center region of the key term cluster and the distance between the center of one or more associated terms and the center of a header term may be proportional to the degree of association between the one or more associated terms and the header term.

In various embodiments, the system may be configured to receive key term input corresponding to a user selection of a representation of a key term, including a header term or a an associated term. In various embodiments, the system may be configured to determine a subset of information items that relate to the received key term input. In accordance with the embodiments disclosed herein, key term clusters may be provided based on subsets of information items corresponding to the received key term input.

In some implementations, the system may be configured to provide representations of options to select an intensity term analysis component or an emerging term analysis component. In such embodiments, a user may provide input corresponding to a selection of an intensity term analysis or an emerging term analysis. In various implementations, and based on the user input, the system may determine a subset of one or more key terms based on the intensity key term score of the one or more key terms, or one or more key terms based on the emerging key term score of the one or more key terms.

In implementations, the system may be configured to provide a representation of a key term cluster area comprising one or more key term clusters on the display of the user interface, the key term clusters comprising a header term area and an associated term area. In various embodiments, the system may be configured to provide representations of one or more terms of the subset of intensity key terms or representations of one or more terms of the subset of emerging key terms based on the received analysis user input.

In some implementations, the system may be configured to provide a representation of an option to select a cluster comparison mode and determine subsets of key terms from the determined subset of information items based on an intensity term analysis or an emerging term analysis. In some embodiments, the system may be configured to provide a representation of a first key term cluster containing representations of one or more key terms of a subset of intensity key terms and a representation of a second key term cluster containing representations of one or more key terms of a subset of emerging key terms, wherein the first and second key term clusters are displayed simultaneously on the user interface of the display.

In various embodiments, the system may also be configured to determine an entity mention subset of key terms of the key terms, wherein the entity mention subset is determined by filtering out key terms associated with information items that do not have an association with a user selected predefined entity. The system may also be configured to provide a representation a key term cluster containing one or more representations of the entity mention subset of key terms. In this way, and in accordance with the various embodiments disclosed herein, a key term cluster may provide a useful visualization of key terms, and their respective term types and associations, having an association with various entities.

### BRIEF DESCRIPTION OF THE DRAWINGS

FIG. 1 illustrates a diagram of a system for facilitating queries of a topic-based-source-specific search system using key term clusters, in accordance with one or more implementations.

FIG. 2 illustrates an exemplary diagram of a display of a user interface that presents a query input component, selectable entity mention filters, and selectable search tools and information items relating to received input entered via the query input component, in accordance with one or more implementations.

FIG. 3 illustrates a categorization and scoring of terms.

FIG. 4 illustrates a categorization and scoring of header terms and associated terms.

FIG. 5 illustrates an exemplary entity mention filter area illustrating selectable predefined entity types.

FIG. 6 illustrates an exemplary entity mention filter area illustrating selectable predefined entities and filters.

FIG. 7 illustrates exemplary diagrams of components relating to information items and sources on a display of a user interface, in accordance with one or more implementations.

FIG. 8 illustrates a display of a graphical user interface having a key term cluster area.

FIG. 9 illustrates the header term area and associated term areas of several key term clusters.

FIG. 10 illustrates several key term clusters having rectangular graphical objects.

FIG. 11 illustrates a key term cluster having circular graphical objects.

FIG. 12 illustrates a cluster comparison mode.

FIG. 13 illustrates a flowchart of processing operations for facilitating queries of a topic-based-source-specific search system using key term clusters, in accordance with one or more implementations.

FIG. 14 illustrates a flowchart of processing operations for facilitating queries of a topic-based-source-specific search system using key term clusters and a cluster comparison mode, in accordance with one or more implementations.

The figures are not exhaustive and do not limit the present disclosure to the precise form disclosed.

### DETAILED DESCRIPTION

In the following description, for the purposes of explanation, numerous specific details are set forth in order to provide a thorough understanding of the implementations of the disclosure. It will be appreciated, however, by one skilled in the art that the implementations of the disclosure may be practiced without these specific details or with an equivalent arrangement. In other instances, well-known structures and devices are shown in block diagram form in order to avoid unnecessarily obscuring the implementations of the disclosure. It should be noted that features (e.g., components, operations, or other features) described herein may be implemented separately or in combination with one another.

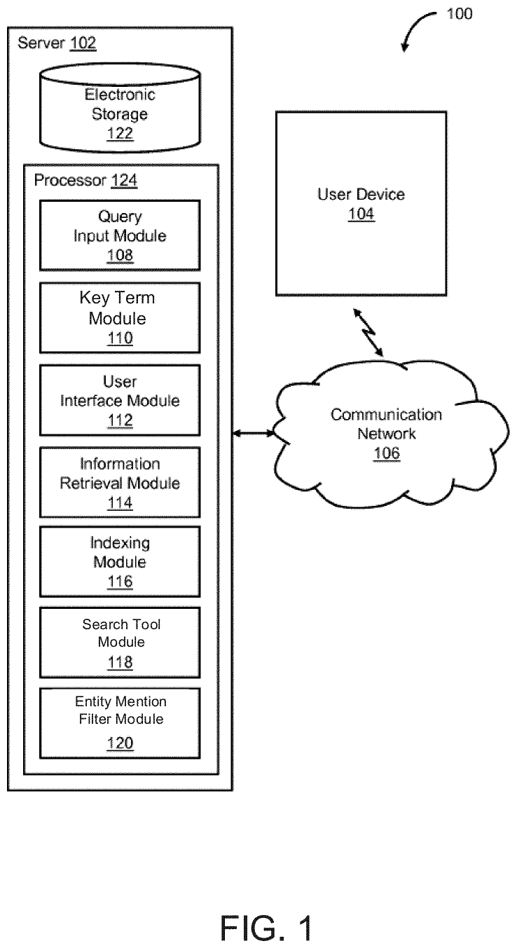

FIG. 1 illustrates a diagram of system 100 for facilitating queries of a topic-based-source-specific search system using mention filters and search tools, in accordance with one or more implementations. System 100 may comprise the topic-based-source-specific search system. The topic-based-source-specific search system may include one or more servers 102. Server 102 (or servers 102) may be configured to communicate with one or more user devices 104 according to a client/server architecture (e.g., over communication network 106 or via other communication medium). Users may access system 100 via one or more user devices 104.

Server 102 may be configured to execute one or more computer program modules to facilitate queries of a topic-based-source-specific search system using mention filters. The computer program modules may include a query input module 108, a suggestion module 110, a user interface module 112, an information retrieval module 114, an indexing module 116, a search tool module 118, a120, or other modules.

In certain implementations, the topic-based-search-specific search system may be configured to collect information from predefined sources relating to a content topic prior to queries of the topic-based-search-specific search system. In some implementations, the content topic may correspond to government information or other type of information. The search system may, for example, determine the predefined sources and collect information from the predefined sources using techniques as described in U.S. patent application Ser. No. 11/430,145, entitled “System and Method for Collecting, Processing, and Presenting Selected Information From Selected Sources via a Single Website,” filed May 9, 2006, which is hereby incorporated by reference in its entirety. Further, the search system may collect and store information, including in metadata form, on information items relating to an association between the information items and one or more predefined entities; information associating the predefined sources corresponding to the information items with a set of sources related to a search tool source set; or information related to an association between information items and one or more key terms, having one or more term types.

Query input module 108 may be configured to receive an input relating to a query. In one scenario, the received input may correspond to a portion of a query that a user has not yet submitted or otherwise completed. The received input may, for instance, represent at least a portion of a query that the user may submit. In another scenario, the received input may correspond to a complete query. In certain implementations, the topic-based-search-specific search system may be configured to provide one or more information items and corresponding sources based on user input as described in U.S. patent application Ser. No. 13/911,565, entitled “Queries of a Topic-Based-Source Specific Search System,” filed Jun. 6, 2013, which is hereby incorporated by reference in its entirety.

In various implementations, query input module 108 may receive a second input relating to the query responsive to the set of suggestions (that include a group of suggestions relating to the suggested sources, a group of suggestions relating to the suggested information items, a group of suggestions relating to the suggested keywords, or a group of other suggestions) provided by user interface module 112. In one use case, the received second input may correspond to a selection of at least one of the provided suggestions.

In certain implementations, the information items of the predefined sources may relate to press releases, speeches, opinions, statements, legislations, or other government information. Formats of the information items may correspond to one or more of textual formats, image formats, audio formats, video formats, or other formats. In some implementations, the information items may relate to press releases, articles, bills, laws, or other types of government information. In some implementations, information data may indicate an association between an information item and one of a plurality of predefined entities. For example, mentioning the name of the predefined entity, or any alias associated with the predefined entity, in the information item may indicate an association. An entity mention may be in any text, audio, video, or any other format or medium interpretable by digital processes or understandable by humans. In some implementations, information data may indicate an association between an information item and one or more terms. For example, an information item containing one or more terms, whether the term is in text or another format, may be associated with the one or more terms.

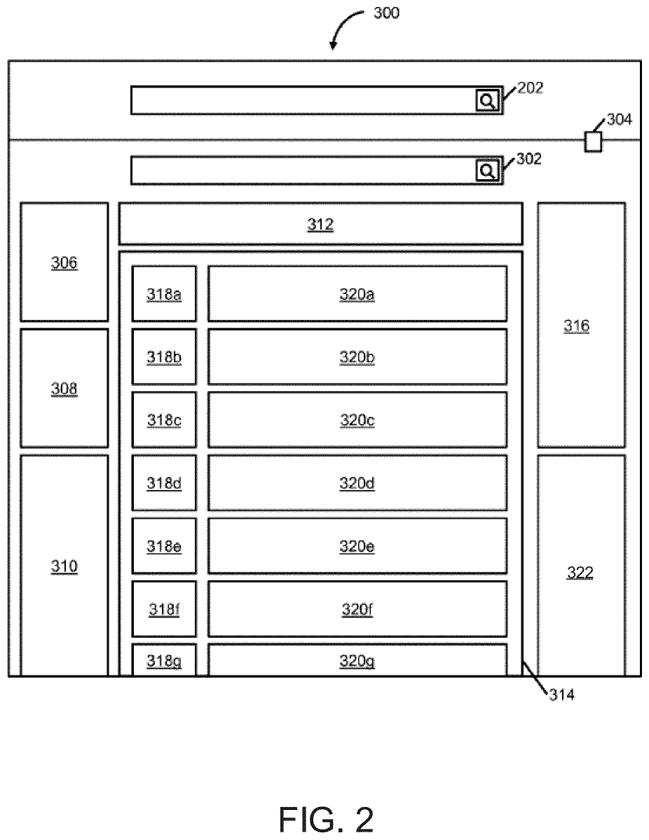

In certain implementations, query input module 108 may be configured to receive a input relating to a query. In some implementations, and referring to FIG. 2, user interface module 112 may be configured to provide a query input component 202 on a display of the user interface. The query input component 202 may, for example, be configured to receive input corresponding to a query. In some implementations, query input module 108 may be configured to receive a second input relating to the query responsive to providing a set of suggestions provided by the system (that includes a group of suggestions relating to the suggested sources, a group of suggestions relating to the suggested information items, a group of suggestions relating to the suggested keywords, or a group of other suggestions).

Information retrieval module 114 may be configured to determine a subset of information items that relate to the received input. Information retrieval module 114 may be configured to determine one or more sources associated with the determined subset of the information items. User interface module 112 may provide one or more representations of the determined subset of the information items and one or more representations of corresponding determined sources on the display of the user interface simultaneously with the query input component. In some implementations, user interface module 112 may be configured to provide an entity mention filter area 316 on the display 300 of the user interface. The entity mention filter area 316 may contain one or more options to select filters relating to one or more predefined entities, where the entities are visually organized by entity type. User interface module 112 may be configured to receive user input corresponding to a selection and application of one or more entity mention filters.

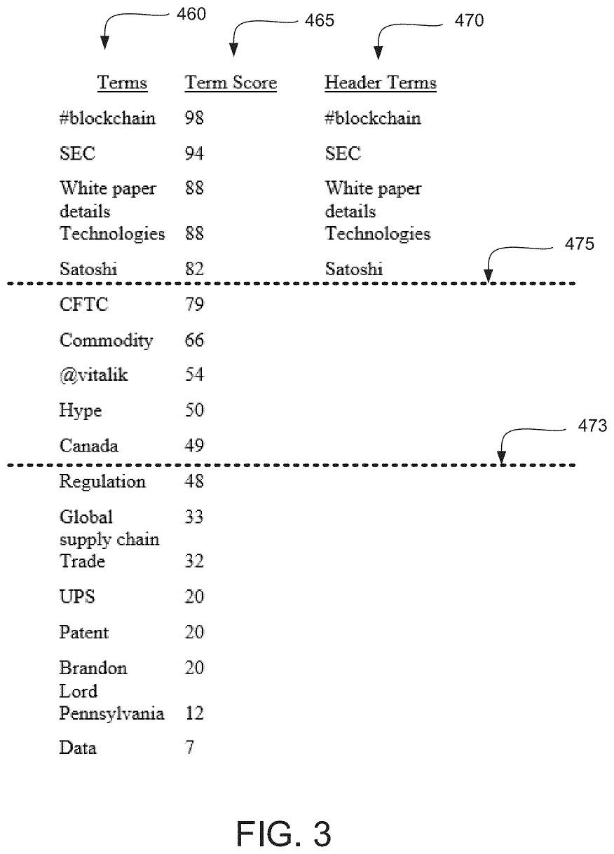

FIG. 3 illustrates an exemplary diagram of a display 300 of a user interface, in accordance with one or more implementations. Display 300 may include query input components 202 and 302. In one use case, query input component 202 may be configured to receive input for a new search query. Query input component 302 may be configured to receive input to search within a current set of search results. Representation 304 may be a representation of an option to enter into a key term cluster view area, where the key term cluster view area provides graphical representations of key terms associated with the information items of the search results.

As depicted by FIG. 3, for example, display 300 may include feed area 306, search tool area 312, a primary information item area 314, a secondary information area 322, and an entity mention filter area 316. Primary information item area 314 may include one or more source representation areas 318 and corresponding information item description areas 320. In one embodiment, responsive to selection of a suggested keyword via a drop-drop menu of suggestions that is presented based on a first input entered into query input component 202, information items that relate to the suggested keyword may be determined along with one or more sources that are associated with the determined information items. Representations of the determined sources and representations of the determined information items may be presented on primary information item area 314 (e.g., source representation areas 318, information item description areas 320, etc.) and secondary information item area 322. Representations of entities organized by entity type, along with options to select one or more entity mention filters may be provided by user interface module 112 in entity mention filter area 316. In certain implementations, information retrieval module 114 may be configured to determine a subset of information items relating to input received by query input module 108.

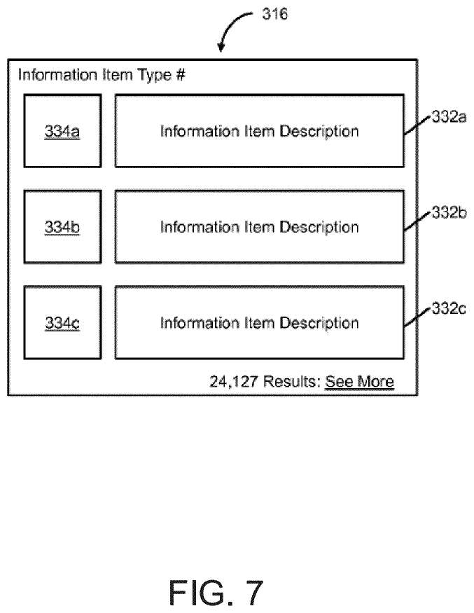

With respect to FIG. 7 individual ones of the information items related to input received by query input module 108 may be represented by item description areas 320 in primary information item area 314 alongside a corresponding source representation area 318 (e.g., that includes a graphical representation of the source), and individual ones of the information items may be represented by item description areas 332 in secondary information item area 322 alongside a corresponding source representation area 334 (e.g., that includes a graphical representation of the source). Individual ones of the item description areas 320 in primary information item area 314 may include more area for details (e.g., title of an information item, type of an information item, number of words in an information item, length or duration of an information item, date of an information item, etc.) relating to the corresponding information item than individual ones of the item description areas 332 in secondary information item area 322.

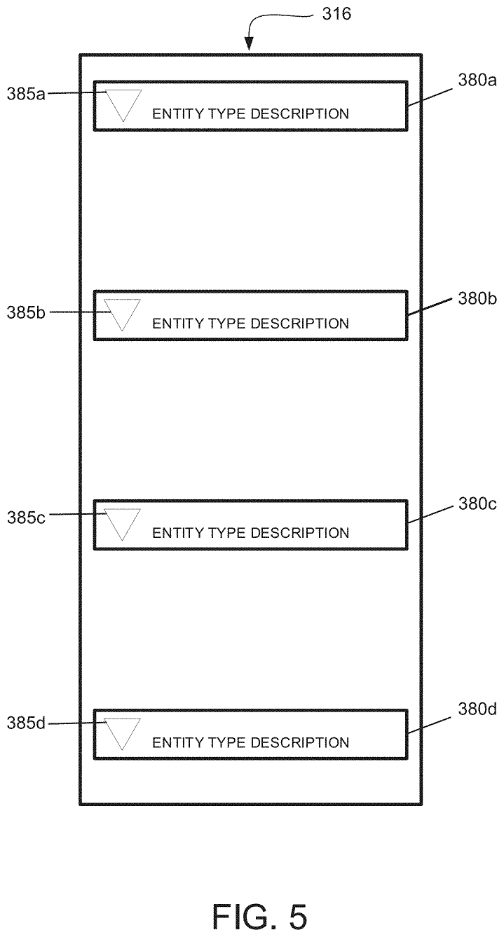

In some implementations, referring to FIG. 5, user interface module 112 may be configured to provide one or more representations of options to select or unselect one or more of a plurality of predefined entity types 380 in the entity mention filter area 316 on display 300 of the user interface simultaneously with the query input component 202, the representations of the determined sources 318, the primary area 314, and the secondary area 316. User interface module 112 may be configured to provide one or more representations of descriptions of the one or more entity types.

In one or more implementations, predefined entities associated with the plurality of predefined entity types 380 may hidden, collapsed, or otherwise removed from view on display 300 while the predefined entity types 380 remain unselected. In some implementations, user interface module 112 may provide one or more representation 385 in entity mention filter area 316 indicating whether an entity type 380 has been selected. For example, in FIG. 5, the default representations 385 may indicate that the entity types 380 have not been selected.

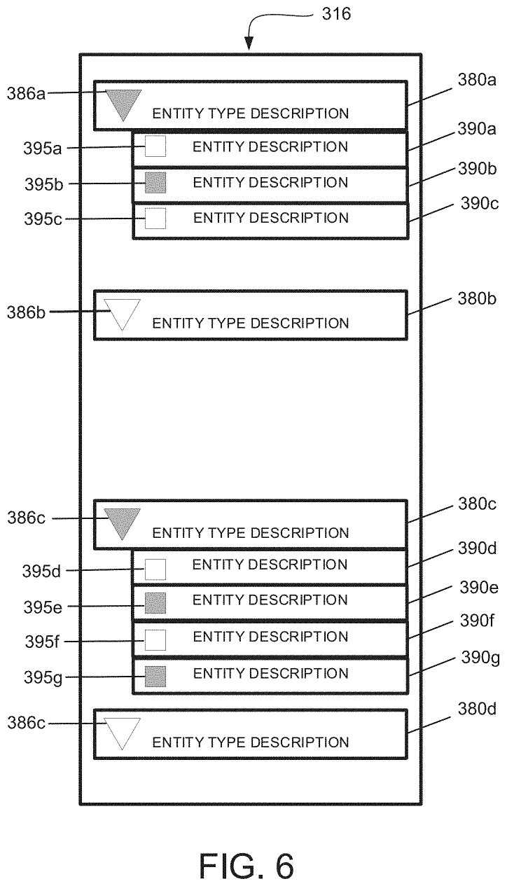

In some implementations, and referring to FIG. 6, the predefined entities 390 associated with the plurality of predefined entity types 380 may be represented by user interface module 112 in entity mention area 316 on display 300 when one or more of the plurality of predefined entity types 380 remain selected. For example, alternate representations 386a and 386c may indicate that the entity types 380a and 380c, respectively, have been selected.

Entity mention filter area 316 may include selectable predefined entities 390. In some embodiments, responsive to an entity type 380 being a selected, representations of predefined entities 390 associated with the entity types may be provided in entity mention filter area 316. For example, responsive to entity type 380c being selected, representations of predefined entities 390d-g associated with entity type 380c may be provided in entity mention filter area 316. Multiple predefined entities associated with different entity types may be provided simultaneously. For example, the predefined entities associated with both entity types 380a and 380c are provided.

User interface module 112 may receive user input of a selection of one or more of the predefined entities. User input may be received through any form of computational input, include input in the form of a mouse click, voice command, gesture, or touch screen input. User interface module 112 may provide a graphical representation 385 indicating whether one or more of the plurality of predefined entity types has been selected. Further, user interface module 112 may provide a graphical representation 395 indicating whether one or more of the plurality of predefined entities has been selected. For example, the graphical representations 395b, 395e, and 395g indicate that predefined entities 390b, 390e, and 395g have been selected by a user.

The selection of one or more of the predefined entities may correspond to the application of an entity mention filter by entity mention filter module 120. That is, by selecting one or more of the predefined entities 390, the user may cause to initiate, or prepare to initiate, an application of one or more entity mention filters by entity mention filter module 120 corresponding to the one or more selected predefined entities 390. As discussed herein, user interface module 112 may be configured to provide one or more representations of information items in a first area on the display of the user interface. Likewise, user interface module 112 may be configured to provide one or more representations of information items determined by entity mention filter module 120 through application of one or more of the entity mention filters.

In one use case, referring to FIG. 6, predefined entity 390b may be selected as a first entity mention filter, and predefined entities 390e and 390g may be selected as second entity mention filters. As such, for instance, information items of the determined subset that relate to entities described by the entity mention filters 390b, 390e, and 390g may be determined by entity mention filter module 120 and represented by user interface module 112 in display 300. In this way, among other benefits, system 100 may enable users to locate and visualize information items and their corresponding information sources that are associated with predefined entities.

The entity mention filter module 120 may determine a set of information items based on an application of an entity mention filter. In various implementations, an entity mention filter may determine a set of information items having an association with a predefined entity and one or more predefined entity aliases. Entity mention filters may enable refinement of the sources and information items that are represented in primary information item area 314 or secondary information item area 322. In some embodiments, an entity mention filter may be applied on the determined subset of information items by entity mention filter module 120 after being selected in entity mention filter area 316 on a display 300 of a user interface.

In various implementations, entity mention filter module 120 may retrieve one or more information items that mention, contain, relate to, describe, or reference one or more predefined entities aliases corresponding to one or more of the predetermined entities 390. Entity mention filters may relate to one or more predefined aliases relating to one or more of the predefined entities. For example, in the case of corporate entities, the entity “The Coca Cola Company” may have one or more predefined aliases, including “Coca Cola” or “Coke.” Predefined aliases may include abbreviations and nicknames. For example, the “NAACP” or “N.A.A.C.P.” may be stored as an entity alias corresponding to the predefined entity, the “National Association for the Advancement of Colored People.” Further, predefined aliases may preserve any stylization, character, or capitalization uniqueness of a known entity to ensure that entity mention filter module may capture all relevant information relating to entity mention filters selected by a user. For example, “D.A.R.E.” may be a predefined alias relating to the predefined entity “DARE” This provides advantages when the capitalization or punctation is relevant to the known name of a predefined entity. Any abbreviation, term, or phrase containing text information serving to facilitate an entity mention filter relating to a predefined entity may serve as a predefined entity alias. In other embodiments, the entity mention filter module 120 may consider the context or circumstances of the apparent presence of a predefined entity alias contained in an information item. For example, the a search for entities containing commonly used words may return search results not relevant to a user's desired search. In various embodiments, the entity mention filter module 120 may require a threshold number of mentions of one or more predefined aliases before indicating an association.

In certain implementations, indexing module 116 may be configured to store metadata in association with the predefined sources or the information items of the predefined sources. The metadata may indicate various attributes relating the predefined sources or the information items. In some implementations, the metadata may indicate an association between an information item and one or more predefined entity types 380, corresponding predefined entities 390, and corresponding predefined entity aliases. Thus, in some embodiments, determining an association between information items and predefined entities may comprise analyzing the information item metadata. In some implementations, the metadata may indicate an association between an information item and one or more terms. The terms may be names, places, things, people, phrases, addresses, hashtags, social medial handles, or any combination of letters, symbols, numbers, or words. In certain implementations, the metadata may indicate that an information item contains, describes, or mentions one or more terms. In certain implementations, the metadata may indicate a degree of association between an information item and one or more terms, including the number of times the information item contains one or more of the terms. Terms may be predefined, collected, or gathered from libraries.

In certain implementations, search tool module 118 may be configured to define a source set associated with a search tool. The source set may, for instance, include at least one source associated with a search strategy. User interface module 112 may be configured to provide one or more representations to modify a search tool on the display of the user interface simultaneously with the query input component, the representations of the information items (e.g., the subset of the information items that relate to the received input), and the representations of sources (e.g., the sources of the predefined sources that relate to the determined subset of the information items). User interface module 112 may be configured to provide one or more representations of information items that are determined by search tool module 118 to be related to a selected search tool. In various implementations, search tool module 118 may be configured to define a source set associated with one or more search tools. A search tool source set may, for example, include one or more predefined sources associated with a search tool. A search tool may organize information items based on a substantive, source-based component consistent with a source-targeted search strategy. User interface module 112 may be configured to provide one or more representations of options to select a search tool in search tool area 312 on the display of the user interface simultaneously with the query input component, the representations of the determined subset of the information items, and the representations of the determined sources (e.g., the sources of the predefined sources associated with the search tools that relate to the determined subset of the information items).

In various implementations, the search tool module 118 may determine one or more information items that are associated with the search tool selected by a user through the user interface module 112. In some implementations, an information item may be associated with a particular search strategy if its corresponds to a source contained within the search tool source set. Thus, the search tool module 118 filters out information items corresponding to sources that are not contained with a selected search tool source set. User interface module 112 may be configured to provide one or more representations of information items that relate to a selected search tool.

In certain embodiments, the information retrieval module 114 may determine a subset of information items and corresponding sources related to input received by the query input module 108. In exemplary embodiments, a key term module 110 may determine one or more key terms contained in one or more of the information items of the determined subset of information items based on a key term determination. In some embodiments, a key term determination may involve determining that a term contained within one or more of the information items has a key term score greater than a threshold value.

The key term module 110 may assign a key term score to any one or more terms contained in, mentioned in, or associated with any one the determined subset of information items. In some embodiments, the key term module 110 scans each information item of the determined subset of information items and assigns a key term score to each term contained therein. In other embodiments, the key term module 110 scans each information item of the determined subset of information items and assigns a key term score to only terms with a recognizable term type, or terms that correspond to predetermined terms located in one or more libraries of terms.

A “term” may be a word, a phrase, an address, a name, a place, or any sequence of characters or numbers. A “term” may be in a digital text format, a digital image format, a digital audio format, or any other digital format.

For example, FIG. 3 illustrates a list of terms 460 retrieved by key term module 110. Key term module 110 may retrieve, gather, or collect any number of terms contained within the one or more information items. The terms may be related to the input of a user query. The key term module may determine which of the terms are key terms by assigning a key term score to each term. In some implementations, a key term score may be based on a key term intensity score, where the key term intensity score is based on one or more of: the number of times the term is contained in the determined subset of information items; or the number of information items in the determined subset of information items containing the term. A key term score may be determined for a subset information items corresponding to one or more time period. In some implementations, a key term score may be determined for one or more sources of information items.

In various implementations, the may be based on a statistical correspondence between the term and the determined subset of information items. As one skilled in the art would appreciation, various algorithms and methods may be applied to determine the level of statistical associations between one or more terms and the determined subset of information items, or more broadly, the frequency by which a key term appears in the determined subset of information items. Such analysis and methods may contribute to the intensity key term score for one or more of the key terms.

In certain implementations, a key term score may be based on an emerging key term score. In such implementations, an emerging key term score may be related to a change in a key term score. In embodiments, an emerging key term score may be based on a change in a high-to-low average of a key term score over one or time periods. For example, key term module 110 may determine a high-to-low average of a key term score a first time period, and a high-to-low average of a key term score for a second time period. Key term module 110 may determine an emerging key term score based on a difference, a rate of change, or a statistical variance between a high-to-low average of a key term score between two or more time periods.

In some implementations, an emerging key term score may comprise determining a key term score based on a key term intensity analysis, for one or more terms contained a subset of information items corresponding to a first time period, and for one or more terms contained a subset of information items corresponding to a second time period. In various implementations, an emerging key term score may be based on the rate of change for a term's key term score during the two time periods, where the key term score may be based on a key term intensity score. That is, the system may be configured to determine a key term intensity score for one or more information items corresponding to a first period, and a key term intensity score for one or more from information items corresponding to a second, later period. If the key term intensity score for a given term increases between the first and second time period, the emerging key term score for that term may increase. Conversely, if the key term intensity score decreases between the first and second time period, the emerging key term score for that term may decrease.

In embodiments, an emerging key term score may indicate whether, or the extent to which, a term is “trending” or not “trending,” based on whether the emerging key term score exceeds a threshold value. Information indicating a “trending” status of a term, and one or more information items associated a term, may be stored by indexing module 116 as metadata.

Consistent with the embodiments disclosed herein, metadata associated with the one or more information items may indicate a time and date of publication, creation, or release. Metadata relating to a time period may be stored in association with one or more information items. Key term module 110 may be configured to receive and analyze metadata in association with one or more information items. In various embodiments, the emerging key term score may be based on a plurality of time periods of different lengths. In various embodiments, the emerging key term score may be based on a time periods selected by a user.

In some embodiments, key term module 110 may determine a key term score based on either the key term intensity score or the emerging key term score, or a combination of both. In some instances, the key term score may reflect an average of the intensity key term score and the emerging key term score. In some implementations, a key term score may be determined based on any scaled or weighted combination of a key term intensity score or an emerging key term score. In FIG. 3, each of the terms 460 have respective ones of corresponding term scores 465. In implementations, the corresponding key term scores 465 may indicate the relative importance of the individual key terms 460 among the one or more information items.

In some embodiments, the key term determination comprises determining that a term contained within one or more information items of the determined subset of information items has a term score greater than a key term threshold value. For example, FIG. 3 illustrates a key term threshold 473. Terms that have a key term score higher than the key term threshold 473 may be determined to be key terms. In some embodiments, a key term determination may comprise selecting a predetermined number of key terms, or a number of key terms that is dependent on the number of information items containing one or more of the key terms for a given subset of information items.

In certain embodiments, the key term module 110 may determine one or more header terms 470 of the key terms based on a header term determination. In various embodiments, the header term determination may comprise determining that a key term has a key term score greater than a header term threshold value. For example, FIG. 3 illustrates a header term threshold 475 indicating a threshold key term score required for a key term to be considered a header term. In this example, five of the ten determined key terms were determined by the key term module 110 to be header terms 470. In other implementations, the header term determination may comprise determining a set of terms having the highest key term score. For example, the key term module may be configured to select any number of terms having the highest key term score to be a key term.

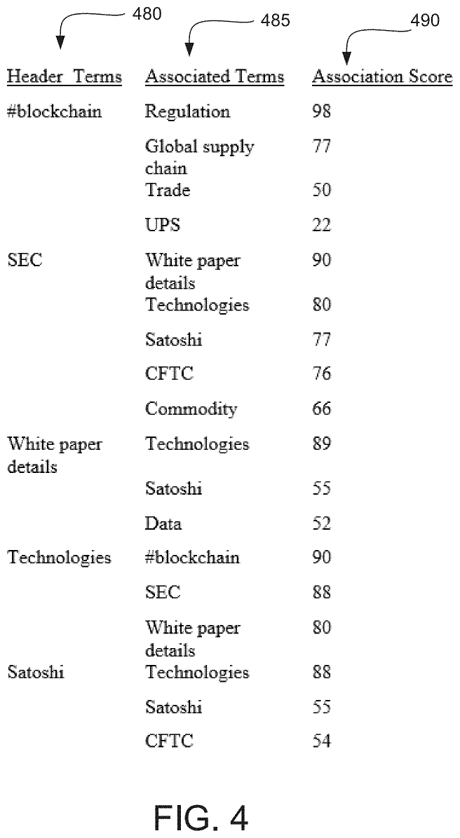

In various embodiments, the key term module 110 may determine one or more associated terms of the key terms based on an associated term determination, wherein each of the associated terms have an association with one or more header terms. In embodiments, all key terms, even terms that are determined to be header terms, may be considered to be associated terms. To illustrate, FIG. 4 shows determined header terms 480 and respective ones of corresponding associated terms 485, each having a respective association score 490. In embodiments, the association score of a given key term represents the association between one or more of the header terms and the given key term. In various implementations, an association score may be determined based on one or more of the number times the key term and the header term are contained in same information item; for information items containing both the key term and the header term, the number times the key term and the header term appear within the information item; for information items containing both the key term and the header term, the character distance between one or more of the key terms and the one or more header terms within the information item; and any statistical correspondence between the header term and the key term.

In certain implementations, the associated term determination comprises determining that a key term and a header term have an association score greater than an association term threshold value. As illustrated in FIG. 4, each of the header terms 480 has one or more associated terms 485. Each of the associated terms may have an association with one or more of the header terms. Terms with an association score that exceed an association score threshold may be considered associated terms. In some instances, some header terms may have more or less associated terms than other header terms. In some instances, some header terms may serve as associated terms to other header terms. As is consistent with the present disclosure, key terms with a low key term score may nevertheless have a high association score, assuming they have a high degree of association with one or more header terms.

Thus, in accordance with the embodiments set for herein, the present disclosure may serve to associate terms with terms that have been determined to have a relatively high key term score, i.e., the header terms. Thus, the organization and indexing of data may relate to terms that are of importance, and corresponding associated terms that may be of secondary, or equal importance depending on the research objectives of those analyzing the data.

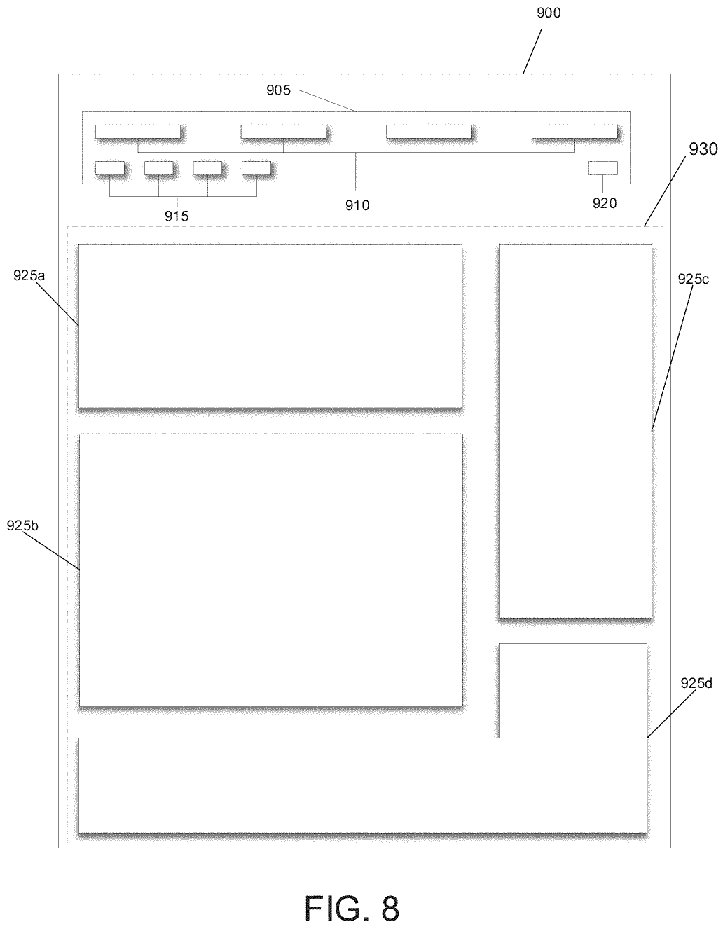

Referring to FIG. 8, the user interface module 112 may provide a representation of a key term cluster area 930 on a display 900 of a user interface. User interface module may provide representations of one or more key term clusters 925. The user interface module 112 may provide a user option input area 905 containing one or more representations 910 for modifying data parameters, and one or more representations 915 for analyzing key term types. For example, representations 915 may display key term types that are associated with various key terms represented in key term cluster area 930. In implementations, key term types may be one or more of a keyword, a name, a place, or an organization. Representations 915 may be provided in different colors depending on the key term type associated with the representation. For example, representations 915 may indicate that “keywords,” may be blue while “names” may be green. There are no limitations on the colors, textures, or effects that may be used by representations 915 to indicate a term type.

In various implementations, representations 910 may be user selectable components providing a user with options to modify parameters relating to the representation of key words in key term cluster area 930. For example, one of representations 910 may provide the user with options to modify a time period of which information items may be used by key term module 110 to determine one or more keywords. In some embodiments, representations 910 may provide a user with a drop down menu to select different time periods associated with different information items. In other implementations, one of representations 910 may provide the user with options to select a different key term cluster view or type. In other implementations, one of representations 910 may provide the user with options to select a different key term scoring system, for example, an key term intensity scoring system or an emerging term scoring system. In various implementations, representations 910 may provide a user with interactive options to modify the displayed information of key term cluster area 930. There may be any number of representations 915 and 910 and the representations need not occupy the top of the display 900.

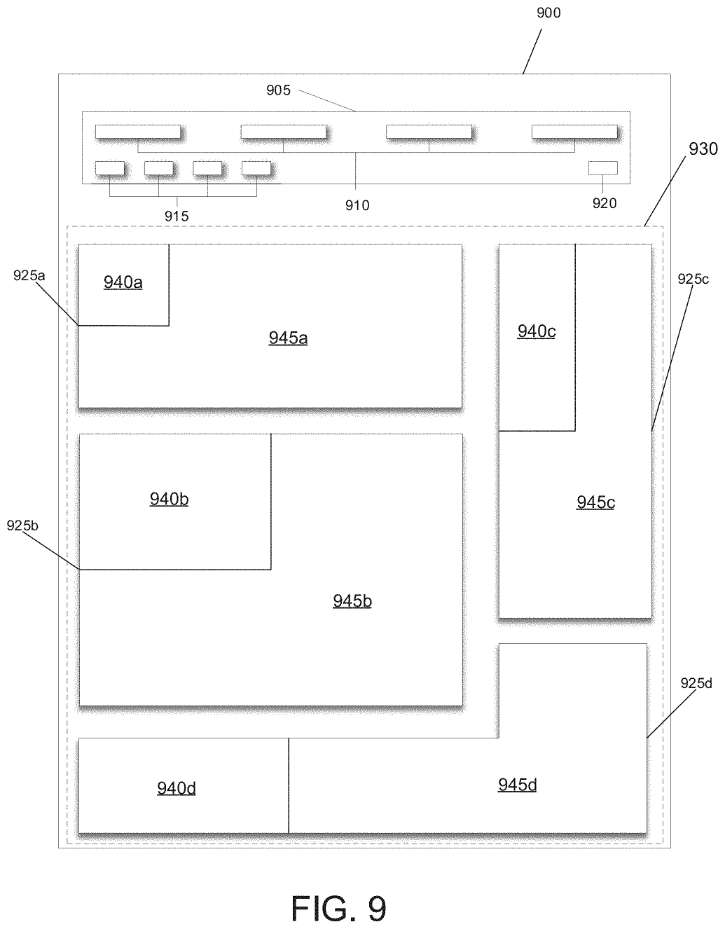

In certain implementations, and referring to FIG. 9, user interface module 112 may provide representations of key term clusters 925, each having a header area 940 and an associated term area 945. In embodiments, header term areas 940 may correspond to or contain header terms determined by key term module 110. Similarly, associated term areas 945 may correspond to or contain one or more associated terms determined by key term module 110. Header terms and their respective associated terms may be represented in the same key term cluster. For example, header term area 940c of key term cluster 925c may correspond to a header term and associated term area 945c may correspond to one or more associated terms that are associated with the header term corresponding to header term area 940c. In this way, and in accordance with the embodiments described herein, the key term cluster may offer a visual cluster representation of the relationship between header terms and their associated terms, thereby aiding the understanding of research data.

In certain implementations, user interface module 112 may provide representations of one key term clusters for each of the header terms determined by key term module 110. In certain implementations, the arrangement of key term clusters 925 within key term cluster area 930 may depend on the key term scores for each of header terms. For example, header term area 940a may correspond to a header term having the highest key term score of any of the header terms. Conversely, header term area 940d may correspond to a header term having the lowest key term score of any of the header terms. In certain implementations, the positioning of a key term cluster may depend on one or more of the key term score of the header term corresponding to the key term cluster, the associated term scores of one or more of the associated terms corresponding to the key term cluster, or a combination both. In certain implementations, the ordering of key term clusters may depend on a left-to-right sequence, a top-to-bottom sequence, or a combination of both.

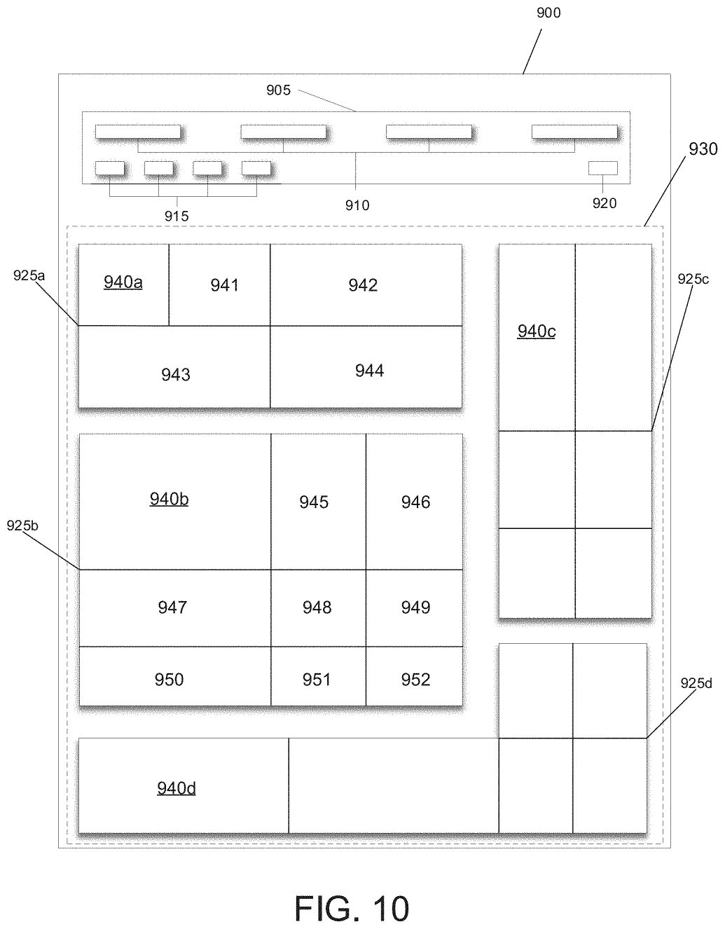

In exemplary embodiments, the user interface module may provide a representation of a header term of the one or more header terms in the header term area 940 of a key term cluster and representations of one or more associated terms of the one or more associated terms in the associated term area 945 of the same key term cluster, wherein the one or more associated terms have an association with the first header term. For example, referring to FIG. 10, key term cluster 925 contains a cluster of key terms 940a and 941-944 of varying size and areas. Of the terms, 940a represents a header term located in a header term area, as determined by the key term module, and key terms 941-944 represent associated terms in the associated term area 945 having an association with header term 940a. Similarly, associated terms 945-952 have an association with the header term represented by 940b in key term cluster 925. Although not shown, key term clusters 925c and 925d may contain representations of header terms and associated terms. There is no limit on the number of key term clusters 925 that may be represented in key term cluster area 930. There is no limit of the number of key terms that may be represented by any one of the one or more key term clusters 925.

In embodiments, the key term clusters 925 may have a shape defined by one or more assembled rectangles. For example, key term cluster 925d has an irregular shape, defined by the assembly of multiple rectangles. In embodiments, the area of a key term cluster 925 may be proportional to the total number of key terms contained therein. In embodiments, the shape of key term clusters 925 may depend on the number of key terms in one or more of the key term clusters. User interface module may be configured to minimize empty space within key term cluster area 930 by assigning a shape and/or size to individual key term clusters 925 based on the total number of key terms contained within one or more key term clusters, the key term scores of one or more key terms, the associated term scores of one or more key terms, a combination of a key term score or an associated term score of one or more of the key terms, or combination of a key term score or an associated term score for one or more of the key terms located within a given key term cluster. Various arrangements consistent with the disclosure are possible.

In some embodiments, user interface module 112 may be configured represent key terms on the display 900 of the user interface as a graphical object having an area and a color, wherein the color may be based on the term type of the key term represented by the graphical object. For example, the key term representation 940a, which is also the header term of the key term cluster 925a, may have a defined color and area represented by the user interface module 112. The color of the key term representation 940a may depend on the term type. For example, if the key term represented by key term representation 940a is a name, then key term representation 940a may be blue. In embodiments, the colors of certain term types may be indicated by one or more of representations 915. In various embodiments, the term types of the individual term represented in the one or more key term clusters may vary. Accordingly, the present disclosure may offer an unique visualization of key terms associated with information item based on the terms' importance, association with other terms, and term type.

In certain embodiments, the area of each graphical object may be based on at least one of the association score or the key term score of the key term represented by the graphical object. As illustrated in FIG. 10, some of the representations of the one or more key terms contained within one or more of the key term clusters 925 may have different sizes. In some embodiments, the size of a representation of a given key term may depend on its key term score, its intensity key term score, its emerging key term score, or its associated term score. In some embodiments, the size of a representation of a given key term may depend on its key term score relative to the header term to which it is associated with. In certain embodiments, the size of a representation of a given key term may depend on the number of other representations of key terms contained within the same key term cluster. In some embodiments, the representations of the header terms 940 for the key term clusters 925 may have the largest area of any representations of associated term contained with the same key term cluster. In certain embodiments, the size of the representations of an associated key term may be weighted based on the key term score of the header term contained with the same key term cluster.

In some embodiments, the representations of header terms 940 may occupy the top-left most position of their respective key term clusters. In alternative embodiments, the representations of header terms 940 may occupy the most central position of their respective key term clusters. In certain embodiments, the positioning of the associated terms in the associated term areas 945 may depend on a sequence that is based on at least an association between each of the associated terms and the header terms corresponding to the associated terms, or a key term score of one of the associated terms. In some embodiments, associated terms of a key term cluster with the highest associated term scores may be positioned adjacent to a corresponding header term of that key term cluster. In alternative embodiments, associated terms of a key term cluster with lower associated term scores may be placed further from header terms. In some implementations, associated terms of a key term cluster may be sequenced depending on an associated term score in a top-down sequence, a left-to-right sequence, or a combination of both.

In certain embodiments, the user interface module 112 may be configured to receive input from a user corresponding to a user selection of the graphical representation of a key term. In certain implementations, the user input may be in the form of a mouse click, a gesture, a voice command, or any other form of user-initiated input. In some implementations, user interface module 112 may cause a representation of a key term to enlarge upon receiving input corresponding to a mouse hover over the representation of the key term. Upon receiving input corresponding to the selection of a representation of a key term, the present system may be configured to determine, by the information retrieval module 114, a subset of information items of the determined subset of information items that relate to the received key term input.

For example, a selection of a representation of a key term may cause the information retrieval module 114 to search within the determined subset of information items for a new subset of information items containing the key term corresponding to the selected representation. In example embodiments, the key term module 110 may determine a new set of one or more key terms, one or more header terms, and one or more associated terms based on the newly determined subset of information items, in accordance with the embodiments disclosed herein. The user interface module 112 may be configured to provide one or more key term cluster areas comprising one or more key term clusters that contain one or more representations of the newly determined set of terms.

In this way, the present invention may offer a useful research tool as it may present information about relevant key terms in the form of visual characteristics (color, size, space, position, order, location relative to other key terms, etc.) and help direct subsequent searches by providing a mechanism to search within results by selecting key terms represented in key term clusters. In certain embodiments, other filters, selected through one or more representations 910 or 915 may be applied on the subset of information items used by the key term module 110. Filters may include filters relating to key term type, text based query search filters, or entity mention filter as discussed herein.

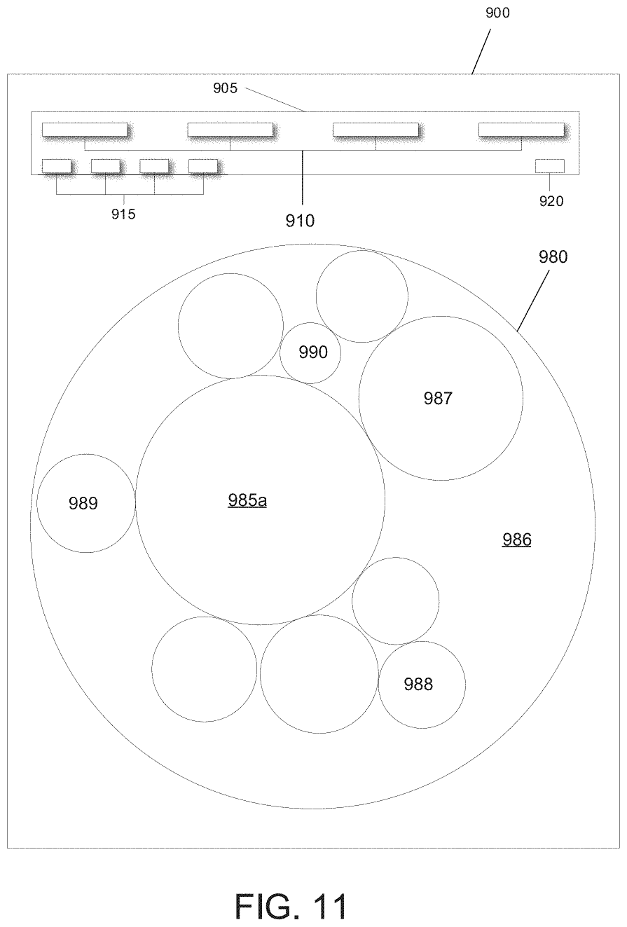

In certain implementations, and as illustrated in FIG. 11, the representation of the key term cluster area, the representations of the key term clusters, the representation of the header terms, and the representations of the one or more first associated terms may be circular. For example, key term cluster 980 may be circular, or substantially circular, and may contain a header term area 985 and an associated term area 986. In certain embodiments, and consistent with the embodiments as described herein, the associated terms 989, 990, 987, and 988, may have a position relative to header term 985 that is proportional to their degree of association with header term 985. In certain embodiments, the representation of header term 985 may be positioned substantially towards the center of key term cluster area 980. FIG. 11 illustrates one key term cluster having one header term and 9 associated terms. In the case of multiple key term clusters, the key term clusters may be positioned towards the center of the key term cluster area 980 based on the key term score of their corresponding header terms.

In various embodiments, user interface module 112 may provide an option to select an emerging key term analysis, wherein the emerging key term analysis gathers a set of key terms from the determined subset of information items having the highest emerging key term score, or a key term intensity analysis, wherein key term intensity analysis gathers a set of key terms from the determined subset of information items having the highest key term intensity score. In some embodiments, user interface module 112 may be configured to represent one or more key term clusters containing a set of key terms from the determined subset of information items having the highest emerging key term score. In some embodiments, user interface module 112 may be configured to represent one or more key term clusters containing a set of key terms from the determined subset of information items having the highest key term intensity score. Thus, in accordance with the key cluster generation as discussed herein, the user interface module may provide one or more key term clusters that are based on the sets of terms determined from the key term intensity analysis or the emerging key term analysis. In certain implementations, and consistent with the disclosure set forth herein, options relating to the selection of specific time periods and/or entity mention filters may be provided to further refine the terms represented in one or more key term clusters.

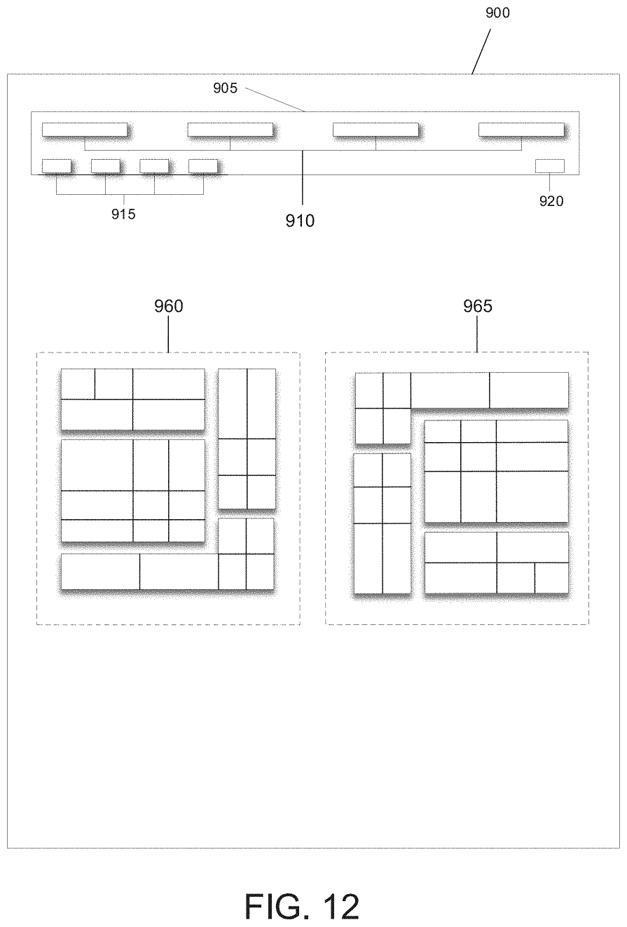

In certain implementations, and referring to FIG. 12, the system may be configured to provide, by the user interface module 112, a representation 920 of an option to select a cluster comparison mode. In various embodiments, a cluster comparison mode may provide a user with an option to view one more key term clusters based on emerging key terms and one or more key term clusters based intensity key terms at the same time. In certain embodiments, upon receipt of input corresponding to the selection of a cluster comparison mode, the user interface module 112 may provide at least two clusters areas 960 and 965, wherein the two different cluster areas comprising one or more key term clusters.

Consistent with the disclosure, various filters may be applied in the cluster comparison mode, including entity mention filters, allowing a user to modify and compare one or more cluster areas using filters and methods as disclosed herein. In accordance with the disclosure, the individual representation of key terms in the cluster comparison mode may receive user input to initiate a search within results based on the selected key term representation.

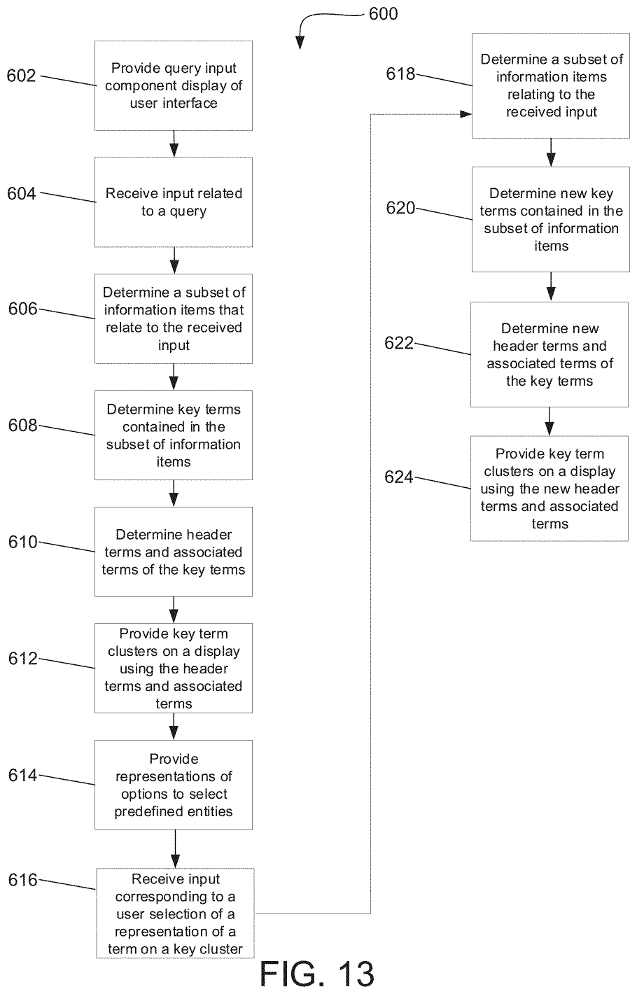

FIG. 13 illustrates a flowchart of processing operations for facilitating queries of a topic-based-source-specific search system using key term clusters. The operations of process 600 presented below are intended to be illustrative. In some implementations, process 600 may be accomplished with one or more additional operations or modules not described, and/or without one or more of the operations discussed. Additionally, the order in which the operations of process 600 are illustrated in FIG. 13 and described below is not intended to be limiting.

In certain implementations, one or more operations of process 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 600 in response to instructions stored electronically on an electronic storage medium. The one or more processing devices may include one or more devices configured through hardware, firmware, and/or software to be specifically designed for execution of one or more of the operations of process 600.

In certain implementations, the topic-based-source-system using key term clusters may be configured to collect information from predefined sources relating to a content topic prior to queries of the topic-based-source-system. In some implementations, the content topic may correspond to government information or other type of information. In certain implementations, the topic-based-source-system may be configured to determine one or more key terms associated with one or more of the information items. In certain implementations, the topic-based-source-system may be configured to provide representations of one or more key term clusters containing one or more the key terms.

In an operation 602, a query input component may be provided on a display 300 of a user interface. The query input component may be configured to receive input. Operation 702 may be performed by a user interface module that is the same as or similar to user interface module 112, in accordance with one or more implementations.

In an operation 604, an input relating to a query may be received. Operation 704 may be performed by a query input module that is the same as or similar to query input module 108, in accordance with one or more implementations.

In an operation 606, a subset of information items of one or more predefined sources may be determined based on the received input. In certain implementations, the information items may relate to one or more of press releases, speeches, opinions, statements, legislation, or other government information. In some implementations, the information items may relate to bills or laws. Operation 606 may be performed by an information retrieval module 112, in accordance with one or more implementations. One or more sources associated with the determined subset of the information items may be determined by an information retrieval module, in accordance with one or more implementations. The determined sources may include one or more political or government sources. The political or government sources may relate to one or more political parties, political or government organizations, political or government figures, or other political or government sources.

In an operation 608, one or more key terms contained within one or more of the information items may be determined from one or more terms contained, referenced, mentioned, described, or otherwise discovered in the one or more information items. In certain implementations, the one or more key terms may be determined based on a key term score for one or more terms. Operation 608 may be performed by a key term module 110, in accordance with one or more implementations.

In an operation 610, one or more header terms and one or more associated terms may be determined from the key terms. In example implementations, one or more header terms may be determined based on their respective key term score or a key term score relative to other key term scores. In example implementations, one or more header terms may be determined based on the number of information items containing one or more key terms. In certain embodiments, one or more associated terms may be determined based on an associated term score. In exemplary embodiments, an associated term score may be based on an association between one or more key terms and a header term. Operation 610 may be performed by a key term module 110, in accordance with one or more implementations.

In an operation 612, one or more key clusters may be provided on a display of a user interface using determined header terms and associated terms. In embodiments, the number of key term clusters provided may depend on the number of header terms determined. In embodiments, the one or more key term clusters may have a header term area and an associated term area. In certain implementations, the header term area may have a visual significance over the associated term area. In certain implementations, a key term cluster may contain a header term and one or more associated terms that have a relatively strong association with the header term. Operation 612 may be performed by a user interface module 112, in accordance with one or more implementations.

In an operation 614, representations of options to select predefined entities may be provided on a display. Operation 614 may be provided by entity mention filter module 120.

In an operation 616, input corresponding to a user selection of a representation of a term on a key term cluster may be received. In some embodiments, the input may correspond to a search within one or more information items. Operation 616 may be provided by entity mention filter module 120.

In an operation 618, a new subset of information items relating to the received input of operation 616 may be determined. In example implementations, the subset of information items may be a subset of information items containing, relating to, describing, mentioning, or otherwise associated with a key term corresponding to a user selection. Operation 618 may be provided by information retrieval module 114.

In an operation 620, a new set of key terms contained in a new subset of information items may be determined, in accordance with the key term determination described herein. In embodiments, the new key terms relate to the new subset of information determined as a result of a user selection. Operation 620 may be provided by key term module 110.

In an operation 622, one or more header terms and one or more associated terms may be determined from the new key terms. Operation 622 may be provided by a key term module 110.

In an operation 624, one or more key term clusters corresponding to the new header terms and new associated terms are provided on a display, in accordance with the embodiments for providing key term cluster provided herein. Operation 622 may be provided by a user interface module 112.

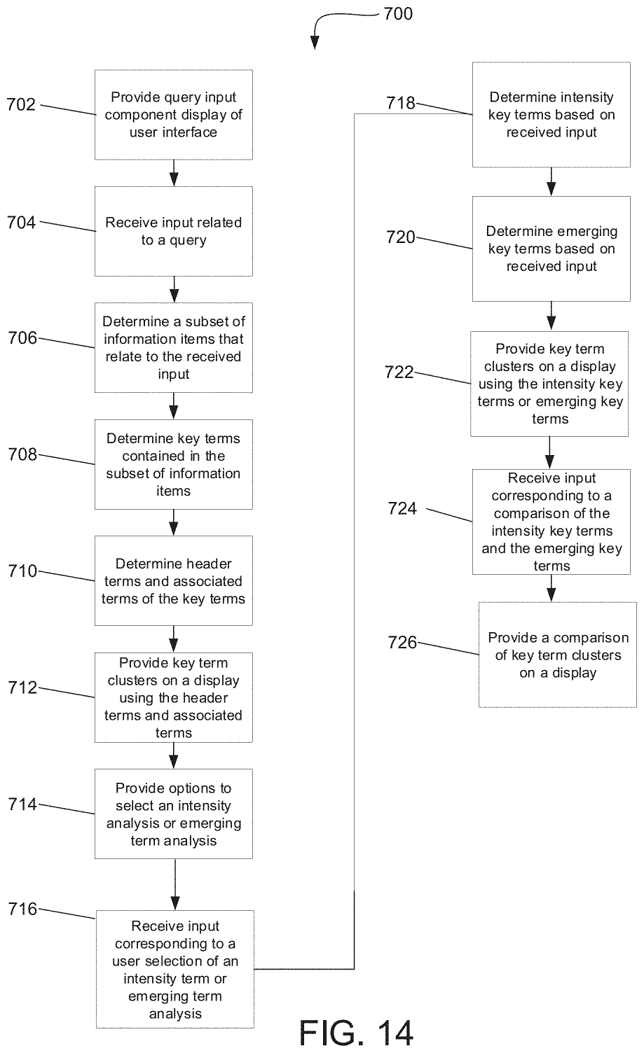

FIG. 14 illustrates a flowchart of processing operations for facilitating queries of a topic-based-source-specific search system using key term clusters. The operations of process 700 presented below are intended to be illustrative. In some implementations, process 700 may be accomplished with one or more additional operations or modules not described, and/or without one or more of the operations discussed. Additionally, the order in which the operations of process 700 are illustrated in FIG. 14 and described below is not intended to be limiting.

In certain implementations, one or more operations of process 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 700 in response to instructions stored electronically on an electronic storage medium. The one or more processing devices may include one or more devices configured through hardware, firmware, and/or software to be specifically designed for execution of one or more of the operations of process 700.

In certain implementations, the topic-based-source-system using key term clusters may be configured to collect information from predefined sources relating to a content topic prior to queries of the topic-based-source-system. In some implementations, the content topic may correspond to government information or other type of information. In certain implementations, the topic-based-source-system may be configured to determine one or more key terms associated with one or more of the information items. In certain implementations, the topic-based-source-system may be configured to provide representations of one or more key term clusters containing one or more the key terms.

In an operation 702, a query input component may be provided on a display 300 of a user interface. The query input component may be configured to receive input. Operation 702 may be performed by a user interface module that is the same as or similar to user interface module 112, in accordance with one or more implementations.

In an operation 704, an input relating to a query may be received. Operation 704 may be performed by a query input module that is the same as or similar to query input module 108, in accordance with one or more implementations.

In an operation 706, a subset of information items of one or more predefined sources may be determined based on the received input. In certain implementations, the information items may relate to one or more of press releases, speeches, opinions, statements, legislation, or other government information. In some implementations, the information items may relate to bills or laws. Operation 706 may be performed by an information retrieval module 112, in accordance with one or more implementations. One or more sources associated with the determined subset of the information items may be determined by an information retrieval module, in accordance with one or more implementations. The determined sources may include one or more political or government sources. The political or government sources may relate to one or more political parties, political or government organizations, political or government figures, or other political or government sources.

In an operation 708, one or more key terms contained within one or more of the information items may be determined from one or more terms contained, referenced, mentioned, described, or otherwise discovered in the one or more information items. In certain implementations, the one or more key terms may be determined based on a key term score for one or more terms. Operation 708 may be performed by a key term module 110, in accordance with one or more implementations.

In an operation 710, one or more header terms and one or more associated terms may be determined from the key terms. In example implementations, one or more header terms may be determined based on their respective key term score or a key term score relative to other key term scores. In example implementations, one or more header terms may be determined based on the number of information items containing one or more key terms. In certain embodiments, one or more associated terms may be determined based on an associated term score. In exemplary embodiments, an associated term score may be based on an association between one or more key terms and a header term. Operation 710 may be performed by a key term module 110, in accordance with one or more implementations.

In an operation 712, one or more key clusters may be provided on a display of a user interface using determined header terms and associated terms. In embodiments, the number of key term clusters provided may depend on the number of header terms determined. In embodiments, the one or more key term clusters may have a header term area and an associated term area. In certain implementations, the header term area may have a visual significance over the associated term area. In certain implementations, a key term cluster may contain a header term and one or more associated terms that have a relatively strong association with the header term. Operation 712 may be performed by a user interface module 112, in accordance with one or more implementations.

In an operation 714, representation of options to select an intensity term analysis or an emerging term analysis may be provided. In some implementations, the representation of options may be in a dropdown menu. Operation 714 may be provided by a user interface module 112, in accordance with the embodiments disclosed herein.

In an operation 716, input corresponding to a user selection of an intensity term or emerging term analysis may be provided. Operation 714 may be provided by a user interface module 112, in accordance with the embodiments disclosed herein.

In an operation 718, one or more intensity key terms may be determined based on the receive input. In embodiments, one or more intensity key terms may be determined if a user selects an intensity key term analysis. In embodiments, one or more intensity key terms may be determined prior to a user selection of an intensity key term analysis. In embodiments, one or more intensity key terms may be determined based on a key term intensity score. Operation 718 may be provided by a user key term module 110, in accordance with the embodiments disclosed herein.

In an operation 720, one or more emerging key terms may be determined based on the receive input. In embodiments, one or more emerging key terms may be determined if a user selects an emerging key term analysis. In embodiments, one or more emerging key terms may be determined prior to a user selection of an emerging key term key analysis. In embodiments, one or more emerging key terms may be determined based on an emerging key term score. Operation 720 may be provided by a key term module 110, in accordance with the embodiments disclosed herein.

In an operation 722, one or more key term clusters may be provided to display one or more representations of the one or more intensity key terms or the one or more emerging key terms, based on the received user input. Operation 722 may be provided by a user interface module 112, in accordance with the embodiments disclosed herein.

In an operation 724, input corresponding to a user selection of a cluster comparison mode may be provided. In example embodiments, a cluster comparison mode may comprise a comparison between one or more intensity key terms and one or more emerging key terms. Operation 724 may be provided by a user interface module 112, in accordance with the embodiments disclosed herein.

In an operation 726, a comparison of one or more key term clusters may be provided. In example embodiments, the cluster comparison mode may comprise displaying two or more key term cluster areas. In example embodiments, one or more key term clusters corresponding to one or more intensity key terms may be compared with one or more key term clusters corresponding to one or more emerging key terms, by being displayed in different key term cluster areas. Operation 726 may be provided by a user interface module 112, in accordance with the embodiments disclosed herein.

User device 104 may comprise any type of mobile terminal, fixed terminal, and/or other device. For example, user device 104 may comprise a desktop computer, a notebook computer, a netbook computer, a tablet computer, a smartphone, a navigation device, an electronic book device, a gaming device, and/or any other user device. In some implementations, user device 104 may comprise the accessories and peripherals of these devices. User device 104 may also support any type of interface to the user (such as “wearable” circuitry, etc.).

Communication network 106 of system 100 may comprise one or more networks such as a data network, a wireless network, a telephony network, and/or other communication networks. A data network may comprise any local area network (LAN), metropolitan area network (MAN), wide area network (WAN), a public data network (e.g., the Internet), short range wireless network, and/or any other suitable packet-switched network. The wireless network may, for example, comprise a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium (e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth, Internet Protocol (IP) data casting, satellite, mobile ad-hoc network (MAN ET), etc.).

In some implementations, server 102 may include an electronic storage 122, one or more processors 124, and/or other components. Server 102 may include communication lines, or ports to enable the exchange of information with a network and/or other computing platforms. Illustration of server 102 in FIG. 1 is not intended to be limiting. Server 102 may include a plurality of hardware, software, and/or firmware components operating together to provide the functionality attributed herein to server 102. For example, server 102 may be implemented by a cloud of computing platforms operating together as server 102.

Electronic storage 122 may comprise non-transitory storage media that electronically stores information. The electronic storage media of electronic storage 122 may include one or both of system storage that is provided integrally (i.e., substantially non-removable) with server 102 and/or removable storage that is removably connectable to server 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor 124, information received from server 102, information received from user devices 104, and/or other information that enables server 102 to function as described herein. In some implementations, electronic storage may comprise a non-transitory, tangible computer-readable storage medium with an executable program stored thereon, wherein the program instructs a microprocessor to perform some or all of the functionality of modules 106, 108, 110, 112, 114, 116, 118, 120, and/or other modules.

Processor 124 is configured to provide information processing capabilities in server 102. As such, processor 124 may include one or more of a digital processor, an analog processor, a digital circuit designed to process information, an analog circuit designed to process information, a state machine, and/or other mechanisms for electronically processing information. Although processor 124 is shown in FIG. 1 as a single entity, this is for illustrative purposes only. In some implementations, processor 124 may include a plurality of processing units. These processing units may be physically located within the same device, or processor 124 may represent processing functionality of a plurality of devices operating in coordination. Processor 124 may be configured to execute modules 106, 108, 110, 112, 114, 116, 118, 120, and/or other modules. Processor 124 may be configured to execute modules 106, 108, 110, 112, 114, 116, 118, 120, and/or other modules by software; hardware; firmware; some combination of software, hardware, and/or firmware; and/or other mechanisms for configuring processing capabilities on processor 124.

It should be appreciated that although modules 106, 108, 110, 112, 114, 116, 118 and 120 are illustrated in FIG. 1 as being co-located within a single processing unit, in implementations in which processor 124 includes multiple processing units, one or more of modules 106, 108, 110, 112, 114, 116, 118, and/or 120 may be located remotely from the other modules. The description of the functionality provided by the different modules 106, 108, 110, 112, 114, 116, 118, and/or 120 described below is for illustrative purposes, and is not intended to be limiting, as any of modules 106, 108, 110, 112, 114, 116, 118, and/or 120 may provide more or less functionality than is described. For example, one or more of modules 106, 108, 110, 112, 114, 116, 118, and/or 120 may be eliminated, and some or all of its functionality may be provided by other ones of modules 106, 108, 110, 112, 114, 116, 118, and/or 120. As another example, processor 124 may be configured to execute one or more additional modules that may perform some or all of the functionality attributed below to one of modules 106, 108, 110, 112, 114, 116, 118, and/or 120.

1. A computer-implemented method of facilitating queries of a topic-based-source-specific search system, the system being configured to collect and visualize information from predefined sources relating to a content topic prior to the queries, the method being implemented by the system that includes one or more processors executing one or more computer program modules which, when executed, perform the method, the method comprising:
providing, by a user interface module, a query input component on a display of a user interface, wherein the query input component is configured to receive input;
receiving, by a query input module, an input relating to a query;
determining, by an information retrieval module, a determined subset of information items that relate to the received input;
determining, by the information retrieval module, a determined subset of sources associated with the determined subset of the information items;
determining, by a key term module, one or more key terms contained in one or more information items of the determined subset of information items based on a key term determination, the one or more key terms having a term type;
determining, by the key term module, one or more header terms of the key terms based on a header term determination;
determining, by the key term module, one or more associated terms of the key terms based on an associated term determination, wherein each of the associated terms have an association with one or more header terms;
providing, by the user interface module, a representation of a key term cluster area comprising a key term cluster on the display of the user interface, the key term cluster containing a header term area and an associated term area;
providing, by the user interface module, a representation of a first header term of the one or more header terms in the header term area of the key term cluster; and
providing, by the user interface module, representations of one or more first associated terms of the one or more associated terms in the associated term area of the key term cluster, wherein the one or more first associated terms have an association with the first header term.

2. The method of claim 1, wherein the term type is one of a keyword, a name, a place, or an organization.

3. The method of claim 1, wherein the key term determination comprises determining that a term contained within one or more information items of the determined subset of information items has a key term score greater than a key term threshold value, wherein the key term score is based one or more of:
an key term intensity score, wherein the key term intensity score of a term is based on one or more of:
the number of times the term is contained in the determined subset of information items;
the number of information items in the determined subset of information items containing the term; and
a statistical correspondence between the term and the determined subset of information items; or
an emerging key term score, wherein the emerging key term score of a term is based on at least:
a change in a key term score, based on a key term intensity analysis, for one or more terms contained in the determined subset of information items over two or more periods, where at least one time period is at least partially before a second time period.

4. The method of claim 3, wherein the header term determination comprises determining that a key term has a key term score greater than a header term threshold value.

5. The method of claim 3, wherein the header term determination comprises determining a set of terms having the highest key term score.

6. The method of claim 3, wherein the associated term determination comprises determining that a key term and a header term have an association score greater than an association term threshold value, wherein the association score is determined based on one or more of:
the number times the key term and the header term are contained in same information item;
for information items containing both the key term and the header term, the number times the key term and the header term appear within the information item;
for information items containing both the key term and the header term, the character distance between one or more of the key terms and the one or more header terms within the information item; and
a statistical correspondence between the header term and the key term.

7. The method of claim 1, wherein a key term is represented on the display of the user interface as a graphical object having an area and a color, wherein the color is based on the term type of the key term represented by the graphical object.

8. The method of claim 6, wherein the first header term and the first associated terms are represented on the display of the user interface as graphical objects having an area, wherein the area of each graphical object is based on at least one of the association score or the key term score of the key term represented by the graphical object.

9. The method of claim 6, wherein the representation of the key term cluster, the representation of the first header term, and the representations of the first associated terms consist of one or more rectangles.

10. The method of claim 1, wherein the header term area occupies the top-left most region of the key term cluster.

11. The method of claim 9, wherein
the header term area is positioned in the top-left most region of the key term cluster; and
the first associated terms are positioned after the first header term in a sequence that is based on at least one of:
an association between one of the first associated terms and the first header term; and
a key term score of one of the first associated term.

12. The method of claim 6, wherein the representation of the key term cluster area, the representation of the key term cluster, the representation of the first header term, and the representations of the one or more first associated terms are circular.

13. The method of claim 12, wherein
the header term area is positioned substantially towards the center region of the key term cluster; and
the distance between the center of the representations of the one or more first associated terms and the center of the representation of the first header term is proportional to the degree of association between the one or more first associated terms and the first header term.

14. A computer-implemented method of facilitating queries of a topic-based-source-specific search system, the system being configured to collect and visualize information from predefined sources relating to a content topic prior to the queries, the method being implemented by the system that includes one or more processors executing one or more computer program modules which, when executed, perform the method, the method comprising:
providing, by a user interface module, a query input component on a display of a user interface, wherein the query input component is configured to receive input;
receiving, by a query input module, an input relating to a query;
determining, by an information retrieval module, a determined subset of information items that relate to the received input;
determining, by the information retrieval module, a determined subset of sources associated with the determined subset of the information items;
providing, by the user interface module, one or more representations of a key term cluster area comprising a key term cluster on the display of the user interface, the key term cluster containing a header term area and an associated term area associated with one or more key terms;
providing, by the user interface module, a representation of a first header term in the header term area; and
providing, by the user interface module, representations of one or more first associated terms in the associated term area of the key term cluster, wherein the one or more first associated terms have an association with the first header term.

15. The method of claim 14, further comprising:
receiving, by the user interface module, a key term input corresponding to a user selection of a representation of the first header term or a representation of one of the first associated terms; and
determining, by the information retrieval module, a key term subset of information items of the determined subset of information items that relate to the received key term input.

16. The method of claim 15, further comprising:
determining, by a key term module, one or more key terms contained in one or more information items of the key term subset of information items based on a key term determination, the one or more key terms having a term type;
determining, by the key term module, one or more header terms of the key terms based on a header term determination;
determining, by the key term module, one or more associated terms of the key terms based on an associated term determination, wherein each of the associated terms have an association with one or more header terms; and
providing, by the user interface module, one or more representations of one or more key term clusters, the one or more key term clusters each containing at least one header term and two associated terms.

17. The method of claim 14, further comprising:
providing, by the user interface module, representation of options to select an intensity term analysis component or an emerging term analysis component;
receiving, by the user interface module, analysis input corresponding to a selection of an intensity term analysis component or an emerging term analysis component;
determining based on the received analysis input, by the key term module, a subset of intensity key terms based on a key term intensity score, the subset of intensity key terms having a header term and one or more associated terms; and
determining based on the received analysis input, by the key term module, a subset of emerging key terms of the key terms based on an emerging key term score, the subset of emerging key terms having a header term and one or more associated terms.

18. The method of claim 17, further comprising:
providing, by the user interface module, a representation of a key term cluster area comprising one or more key term clusters on the display of the user interface, the key term clusters comprising a header term area and an associated term area,
providing, by the user interface module, representations of one or more terms of the subset of intensity key terms or representations of one or more terms of the subset of emerging key terms based on the received analysis user input.

19. The method of claim 14, further comprising:
providing, by the user interface module, a representation of an option to select a cluster comparison mode;
determining, by the key term module, a subset of intensity key terms from the determined subset of information items based on an key term intensity score;
determining, by the key term module, a subset of emerging key terms from the determined subset of information items based on an emerging key term score;
providing, by the user interface module, a representation of a first key term cluster area containing representations of one or more key term clusters based on the subset of intensity key terms; and
providing, by the user interface module, a representation of a second key term cluster containing representations of one or more key term clusters based on subset of emerging key terms, wherein the first and second key term clusters are displayed simultaneously on the user interface of the display.

20. The method of claim 16, further comprising:
determining, by the information retrieval module, an entity mention subset of key terms of the key terms, wherein the entity mention subset is determined by filtering out key terms associated with information items that do not have an association with a user selected predefined entity;
providing, by the user interface module, a representation a key term cluster containing one or more representations of the entity mention subset of key terms.
